(19) United States
(12) Patent Application Publication
(10) Pub. No.: US 2009/0083107 A1
(43) Pub. Date: Mar. 26, 2009

(54) METHOD AND SYSTEM FOR STRATEGIC GLOBAL RESOURCE SOURCING

(75) Inventors: Ching-Hua Chen-Ritzo, Mahopac, NY (US); Daniel Patrick Connors, Pleasant Valley, NY (US); Markus Ettl, Yorktown Heights, NY (US); Mayank Sharma, White Plains, NY (US); Karthik Sourirajan, White Plains, NY (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 11/860,336

(22) Filed: Sep. 24, 2007

(51) Int. Cl. G05B 17/00

(52) U.S. Cl. 705/8

(57) ABSTRACT

Method and system for strategic global resource sourcing in one aspect incorporates concurrently a plurality of qualitative and quantitative attributes that influence performance of sourcing strategy with respect to one or more quantitative measures, quantifies an impact of said qualitative attributes using said one or more quantitative measures, and optimizes the sourcing strategy with respect to said one or more quantitative measures subject to one or more constraints.

### FIELD OF THE INVENTION

The present disclosure generally relates to strategic global resource sourcing, and particularly to determining global resource sourcing strategies by integrating qualitative and quantitative aspects of resources and constraints within a single framework.

### BACKGROUND OF THE INVENTION

An important challenge in shifting to globally integrated enterprises is planning the location and capacity of the global workforce. There is a need to provide a robust and reusable sourcing template to identify new/expand existing global resource pools, analyze trade-off between qualitative and quantitative aspects across multiple global locations and model the global nature of resource sourcing. While resource sourcing involves both qualitative and quantitative aspects, existing methods do not adequately consider both aspects in combination. For example, existing methods may consider both qualitative and quantitative aspects of sourcing, but they may be evaluated using two sets of metrics which are not readily comparable. In contrast, this invention allows decision makers to quantitatively explore trade-offs between one or more qualitative factors, or between qualitative and quantitative factors. Therefore, this invention provides a more effective method for making resource sourcing decisions.

Businesses and other organizations are becoming increasingly global in nature. That is, their partners, operations, facilities, employees and customers are increasingly located in multiple countries around the world. Countries may differ in characteristics such as legal system, political system, time zone, currency, language skills, infrastructure, labor rates, standard of living, cost of living and economic stability, just to name a few. Some of these characteristics such as labor rates are straightforward to quantify (for example, using U.S. Dollars), while others such as language skills may be more easily described qualitatively (for example, English Only versus Fluent in Multiple Languages). In order for an organization to efficiently manage resources that are located in multiple countries, these differences will often need to be taken into account. Accordingly, it is desirable to have a method and system for determining an effective sourcing strategy to support a global portfolio of resources, over time, which concurrently incorporates qualitative and quantitative factors, some of which may be non-linear in nature.

Labor wages and material costs constitute significant operating costs for businesses and other organizations. Therefore, it is generally the case that an organization desires to minimize such costs by making careful sourcing decisions. However, these cost reductions should not come at the expense of service or product quality delivered by the organization. By simply minimizing wages and material costs, the organization may indirectly increase other costs such as those associated with poorer quality workers and/or materials (e.g., costs due to loss of customers, lower productivity, increased product returns, high attrition, increased cycle time). Thus, an organization needs to consider both direct and indirect costs associated with its resources. Indirect costs are often difficult to quantify, and are hence likely to be measured using various qualitative, or ‘soft’ factors. For example, the indirect cost associated with productivity loss may depend on the language and other communication skills of workers. Communication skills may in turn be differentiated by a qualitatively defined rank (e.g., level 1, level 2, etc., where a lower level implies better skills).

Suppose that employees hired in country A possess level 1 communication skills while employees in country B possess level 2 communication skills. Additionally, suppose that the job satisfaction level for employees hired in country A is rated to be level 2 while the job satisfaction level for employees hired in country B are rated as level 1, where in this case, a lower level implies a higher job satisfaction. Since communication levels and job satisfaction levels cannot be directly compared, it is useful to quantify (e.g., in terms of cost) differences between levels, both within the same factor and across different factors. Accordingly, it is desirable to have a method and system that allows decision makers to conveniently trade-off one or more qualitatively defined levels between one or more factors in terms of quantifiable, direct, costs.

### BRIEF SUMMARY OF THE INVENTION

A method and system for determining a global resource sourcing strategy for an organization over one or more time periods are provided. The method, in one aspect, may comprise incorporating concurrently a plurality of qualitative and quantitative attributes that influence performance of sourcing strategy with respect to one or more quantitative measures, quantifying an impact of said qualitative attributes using said one or more quantitative measures, and optimizing the sourcing strategy with respect to said one or more quantitative measures subject to one or more constraints.

A system for determining a global resource sourcing strategy for an organization over one or more time periods, in one aspect, may comprise a computer processor operable to incorporate concurrently a plurality of qualitative and quantitative attributes that influence performance of sourcing strategy with respect to one or more quantitative measures. The computer processor may be further operable to quantify an impact of said qualitative attributes using said one or more quantitative measures. An optimizer module optimizes the sourcing strategy with respect to said one or more quantitative measures subject to one or more constraints.

A program storage device readable by a machine, tangibly embodying a program of instructions executable by the machine to perform above-described method may also be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example representation of skills requirement for use in sourcing analysis of the present disclosure in one embodiment.

FIG. 2 shows an example representation of country-by-country supply availability used in sourcing analysis of the present disclosure in one embodiment.

FIG. 3 illustrates system architecture of the present disclosure in one embodiment.

FIG. 4 is a flow diagram illustrating a method for strategic workforce sourcing of the present disclosure in one embodiment.

FIG. 5 is a flow diagram illustrating a method for sourcing analysis in one embodiment of the present disclosure.

### DETAILED DESCRIPTION

A system and method of the present disclosure in one embodiment provide a framework for cost optimization using mathematical models that quantify costs and workforce sourcing metrics. The system and method of the present disclosure in one embodiment integrate the qualitative aspects using rank-based thresholds and tradeoff costs with qualitative gains using scenario analysis on soft requirements.

In one embodiment, the system and method of the present disclosure quantifies “soft” constraints and the trade-off between costs and qualitative gains. The system and method allows decision makers to conveniently trade-off one or more qualitatively defined levels between one or more factors in terms of quantifiable, direct, costs. For instance, the system and method may be used to quantify the difference in direct costs associated with multiple sourcing decisions that have different qualitative characteristics. This allows decision makers to better assess the difference in value between two or more qualitatively defined levels for one or more factors.

Centralized sourcing decisions can benefit from economies of scale when there are fixed costs associated with sourcing from a particular vendor/country. Examples of fixed costs associated with procuring materials from a vendor include, but are not limited to, flat rate shipping costs, or fixed ordering fees. Examples of fixed costs associated with hiring employees from a particular country include, but are not limited to, the cost of facilities and infrastructure to house the operation and support business processes. A method and system of the present disclosure in one embodiment allow decision-makers to optimize on economies of scale by simultaneously considering the sourcing requirements of multiple divisions within the organization and identifying the most effective vendors and countries from which to source labor or materials.

Still yet, a method and system of the present disclosure may address non-linear cost structures and incentive schemes. When dealing with vendors and/or foreign governments, there may exist one or more contracts, which have been negotiated between the organization and the vendor or foreign government, such that the organization may receive certain financial incentives (e.g., discounts, rebates or bonuses) for sourcing certain types and numbers of materials and/or people from the vendor and/or country. These contracts may have complex structures that may be non-linear in nature. A method and system of the present disclosure in one embodiment use mathematical models to capture the structure of the contract(s) and allow the decision-maker to effectively leverage all contracts when making sourcing decisions.

Examples of the types of contracting structures that the method and system of the present disclosure in one embodiment may account for include, but are not limited to, the following: in order to receive a tax rebate of a specific amount from a certain foreign government, the organization must establish a facility in the foreign country and employ a certain number of people possessing a specific set of skills over a specified period of time; the cost for moving people from one location to another may also depend non-linearly on the size of the move due to bulk rebates that one can get from shippers;

In another embodiment, a method and system is provided that address long-term costs and ramp-up and/or ramp-down costs. Sourcing contracts and other sourcing decisions may have long term (e.g., spanning multiple years) effects on an organization's costs. Contracts may specify a minimum and/or maximum time span over which certain sourcing requirements must be met. ‘Ramp-up’ and ‘ramp-down’ costs also have long term effects on an organizations costs since frequent changes in sourcing strategy (e.g., what to procure, whom to hire, and from where) may result in several investments in such costs. Examples of ramp-up costs include, but are not limited to, training of new hires, relocation costs, building of new infrastructure and/or facilities and legal costs for establishing new business relationships. Examples of ramp-down costs include, but are not limited to, closing and/or sale of facilities, severance packages, relocation costs. Effective sourcing strategies consider the trade-off between the day-to-day operational costs and the long term set-up costs. A method and system of the present disclosure in one embodiment provides the ability to consider multiple time periods simultaneously, so that long term costs are not overlooked in favor of short term savings. Break-even points that help determine the time to offset the up-front costs due to ramp-up/ramp-down through reduction in other cost sources can also be analyzed.

In one embodiment, a method and system of the present disclosure determine an effective sourcing strategy to support a global portfolio of resources, over time, which concurrently incorporates qualitative and quantitative factors, and non-linear costs. A sourcing strategy is defined by the global resource portfolio that describes the number of units of resources deployed by country and by resource type (for example, human resources by skill level and/or job type). Quantitative factors comprise those factors that need to be considered when making sourcing strategy decisions to which one can associate a cost value (for example, labor wages in U.S. dollars). The qualitative factors comprise those factors that have to be considered when deciding a sourcing strategy but cannot be quantified using a cost value (for example, political stability of a country). The method and system may be used to determine a sourcing strategy that best optimizes the trade-off between the quantitative and qualitative criteria over time.

In another embodiment, the method and system may take as input a specific set of alternative strategies and evaluate them in terms of their costs and qualitative characteristics over time. The method and system may produce a report, which may advise decision makers regarding the cost(s) associated with a particular sourcing strategy, or a particular set of sourcing strategies. This report may also include a systematic analysis of the cost and qualitative difference(s) between two or more strategies. This report may also include information regarding “break-even” points across alternative strategies as explained above.

While the method and system of the present disclosure is not limited to sourcing human resources, for simplicity purposes, the method and system is described in terms of sourcing people (skills) in an organization as an example. A similar process can be applied for non-human resources as well.

In one embodiment, the method and system of the present disclosure may use the following inputs:
1. A set of skills required such as {Engineers, HR and Programmer}.
2. A set of countries such as {India, China and Hungary}.
3. Organization-wide resource requirement, which for example, gives amount of skills required across the entire organization by skill type. This information may reside in the human resources database of an organization or the internal division databases. This would capture the forecast of the skill requirements in future.

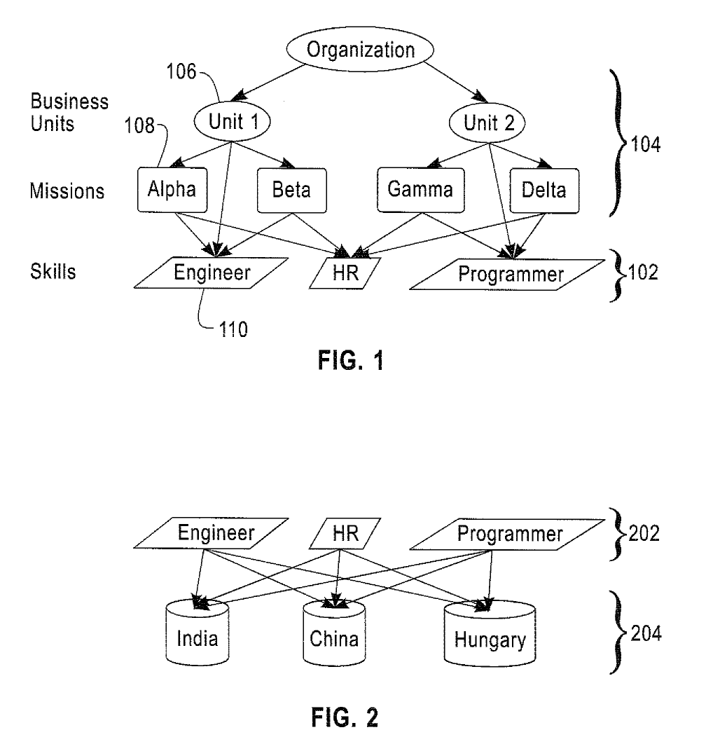

FIG. 1 shows a sample representation of skills requirement. In the FIG. 1, there is defined in one embodiment the skill requirement 102 across the organization by dividing and sub-dividing the organizations into multiple levels 104 such that it is easy to determine the direct skill requirement. Each arrow defines the number of units of the lower level required per unit of the upper level. For example, Unit 1 (106) could need 2 Alpha missions (108) and each alpha mission could in turn require 4 Engineers (110). The number of levels into which the method and system divide an organization (and the type of organizational tree) can be different from what is shown in FIG. 1.
4. Country-by-country supply availability. FIG. 2 shows an example representation of country-by-country supply availability, which provides the amount of resources 202 available in each country 204 by skill type. Each arrow in FIG. 2 may define the number of units of each skill that is available at country level. While FIG. 2 shows Engineers and Programmers as skills in the example, the method and system of the present disclosure do not limit the definition of a skill. For instance, other examples that are more general (for example, IT Specialist) or more specific (for example, Industrial Engineer or Band 7 Programmer) may be used.
5. Contract terms, which for example provide minimum and/or maximum number of workers for each job type employed for a minimum/maximum length of time.
6. Supply-demand matching inputs, which may specify: staff all missions and non-mission skills' requirements, and/or Staff at least ‘X’ missions and ‘Y’ non-mission skills' requirements. Non-mission skills are those skill requirements that are not associated with any mission, but directly associated with the organizational level above missions.
7. Business constraints and preferences, which may include planned actions (e.g., 50% of resources in China by 2010), maximum number of countries staffed by organization, division, sub-division or skill, etc.
8. Incentive contracts, which may specify conditions such as minimum number of missions in a country to qualify for incentives, minimum head count (in total or by individual skill) to qualify for incentives.
9. Qualitative criteria, which may include a list of criteria to consider (such as political stability and language availability), relative ranking of countries for each qualitative criteria, desired thresholds (minimum/maximum rank) for each criteria (by organization, division, sub-division or skill), etc. These thresholds are used to define qualitative constraints which ensure that the sourcing strategy that is chosen satisfies the desired thresholds.
10. Quantitative Criteria such as costs of moving into a country; costs of moving out a country; costs of staffing in a country; costs based on incentive contracts that may include cost and/or reward for violating and/or satisfying incentives, flat amount or discounted labor rates, etc. The cost of a particular sourcing strategy is evaluated using cost functions for the various quantitative criteria considered. The cost functions for a given quantitative criterion may have a variable component and a fixed component. The variable component of a cost function refers to the component that scales with the value of the decision. The fixed component of the cost function refers to the component that is independent of the value of the decision. This invention has the ability to incorporate cost functions whose variable and fixed components may differ based on the range in which the value of the sourcing decisions falls into.

Example of a cost function composed of fixed and variable components:

f(X)=100+5X if 0≦X≦100

and f(X)=500+10X if X>100.

In the above example, suppose f(X) is the cost of staffing, the sourcing decision X represents the number of people staffed at a specific location. The above cost function is defined differently, depending on whether the number of people staffed is in the range [0,100] or the range (100, ∞). When 0≦X≦100, the first term in f(X) (i.e., 100) is the fixed cost component that does not depend on number of people staffed. Meanwhile, the second term is an example of a variable cost since its value varies (in this case, linearly) with the number of people staffed. It for example, a given sourcing strategy has X=50 for that location, we would evaluate the staffing cost for that location using the cost function f(50)=100+5*50=350, since X (=50) lies in the range [0,100]. On the other hand, if X=150, we would evaluate the staffing cost for that location using the function f(150)=500+10*150=2000, since X (=150) is greater than 101. Similar examples can be created for the other quantitative criteria as well. In one embodiment, the range of the sourcing decisions (X in the above example) for which the same cost function applies may be considered to belong to the same ‘level’. In the above example, this means that staffing values in the range [0, 100] belong to one staffing level, and values in the range (100, ∞) belong to another. This is because different cost functions apply when the staffing value lies in one level as opposed to the other.

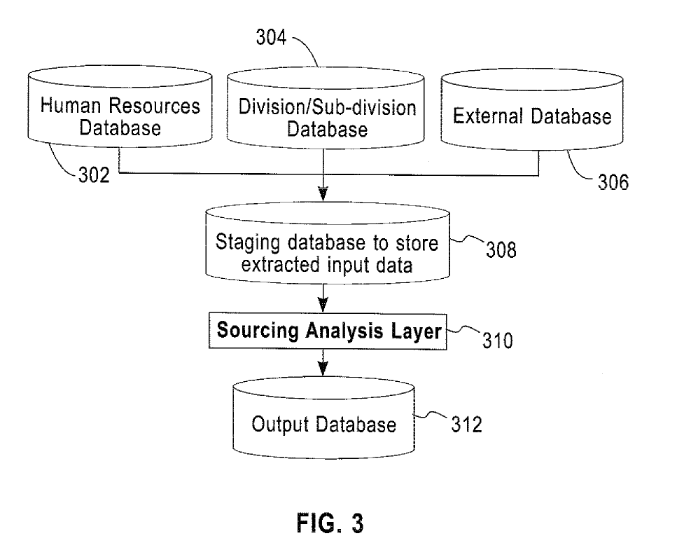

FIG. 3 illustrates system architecture of the present disclosure in one embodiment. Human resource 302 database may include information about human resources, for example, information relating to employees. Division/subdivision database 304 may contain information associated with different levels of units in an organization. External database 306 may contain other information external to the organization. Input data such as those described above are extracted from the databases 302, 304, and/or 306 and used in the analysis 310 of the method and system of the present disclosure. Output database 312 includes data or information obtained from the analysis.

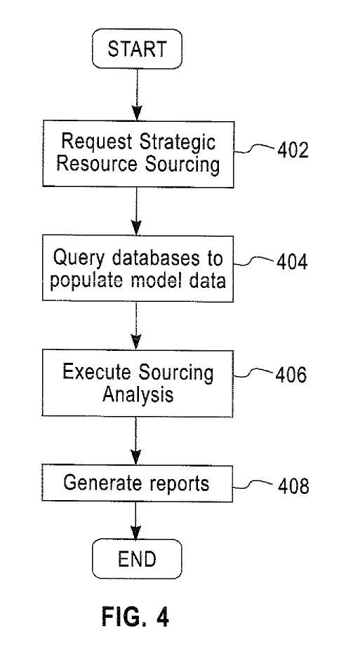

FIG. 4 is a flow diagram illustrating a method for strategic workforce sourcing of the present disclosure in one embodiment. At 402, a request for strategic resource sourcing is received or communicated. At 402, appropriate databases or like that can provide desired information are queried to populate model data, that is data to be input to an analysis model. At 406, sourcing analysis is performed, for instance, by running an analysis model using the input. At 408, the model outputs results and a report may be generated based on the results.

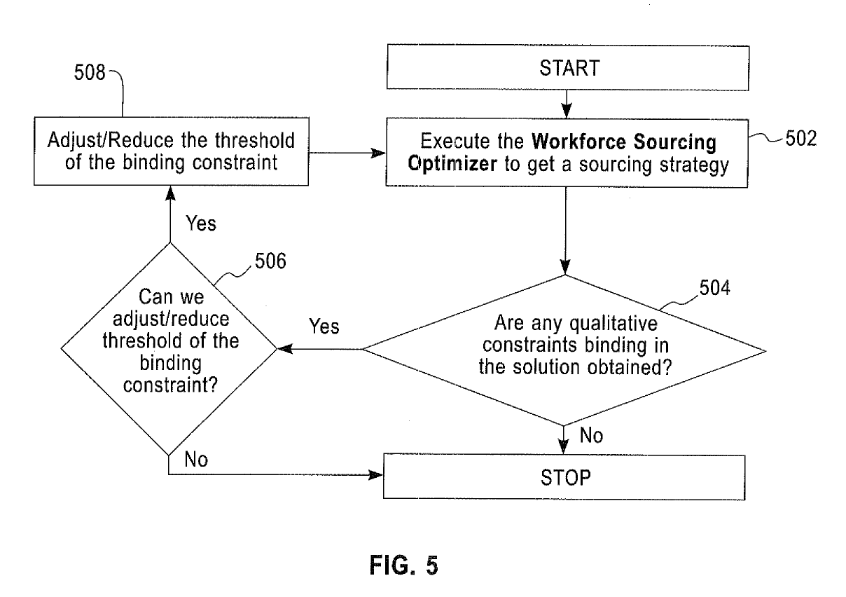

FIG. 5 is a flow diagram illustrating a method for sourcing analysis in one embodiment of the present disclosure. At 502, a workforce sourcing optimizer is run to determine a sourcing strategy solution. At 504, it is determined whether any qualitative constraints are binding in the sourcing strategy solution obtained. A qualitative constraint is considered to be binding if the sourcing strategy solution obtained lies at the boundary of the constraint. For example, let political stability be a qualitative criterion that is considered and let the constraint be that the entire workforce must be sourced from locations with a political stability ranking of 3 or better. Then, if the sourcing strategy solution recommends that all or part of the workforce be sourced from a location with a political stability ranking of exactly 3, we say that the political stability constraint for this location is binding. If there are no qualitative constraints binding in the sourcing strategy solution obtained at 502, the process stops. Otherwise, at 506, it is determined if the threshold of the binding constraint can be adjusted or reduced. If the threshold can be adjusted or reduced, then at 508, the threshold of the binding constraint is adjusted and/or reduced, and the process continues to repeat step 502, using the adjusted and/or reduced values. At 506, if it is determined that the threshold of the binding constraint cannot be adjusted or cannot be reduced, the process stops.

In one embodiment, a workforce sourcing optimizer is a mathematical program that is described below. One or more qualitative constraints are also defined within the mathematical program. The workforce sourcing optimizer in one embodiment generates a sourcing strategy that yields the lowest long-term cost while satisfying the constraints based on the inputs defined earlier.

The notation for the mathematical program in one embodiment is described below:

### Index

c=country
s=skill (at the level of engineering and such)
u=business unit
m=mission
t=year
i=index for staffing level
j=index for ramp-up level
k=index for ramp-down level

Inputs

### Supply, Demand and Business Unit Preferences

aₛₘₜ=amount of skill s required by mission m (Arrow from missions to skills) in year t
bₘᵤ=1, if mission m belongs to unit u; 0, otherwise
a′ₛᵤₜ=amount of skill s required by unit u in year t (non-mission skills or direct demand for skills—arrow between business units and skills)
cur_{mc,}, cur_{sc}=initial state of missions m and skills s in countries c (Current staffing given by number of people staffed by skill by country)
ub_{sct}=maximum availability of skill s in country c in year t
ubcᵤₜ=maximum number of countries for business unit u in year t

Contracts
lbm_{ct}=minimum number of missions required in country c in year t (by contract)
lb_{sct}=minimum head count on skill s that should be sourced in country c in year t
lb^{tot}_{ct}=minimum head count in country c in year t

Staffing Level Inputs
cap_{ic}=upper limit of staffing level i in country c (each level refers to a step)
ru_{jc}=upper limit of ramp-up level j in country c
rd_{kc}=upper limit of ramp-down level k in country c

Qualitative criteria
Q=set of qualitative criteria to consider, q=1, . . . , Q
rho_{cq}=rank of country c for criteria q
Threshold_{uq}=Minimum rank of criteria q desired by business unit u

While the above threshold is defined at a business unit level, the formulation can be easily modified to include it at any level. Further, in this embodiment we consider a higher rank to imply better quality. Thus, the thresholds are defined as minimum ranks. We can easily modify this formulation to capture situations where higher ranks would imply lower quality and define the threshold as the maximum rank in such cases.

### Variable Costs

lr_{sct}^{io}=Labor rate for skill s in country c in year t if we meet incentive requirements
lr_{sct}^{hi}=Labor rate for skill s in country c in year t if we do not meet incentive requirements
c_{sct}ⁱⁿ=linear ramp-up costs for skill s in country c in year t
c_{sct}^{out}=linear ramp-down costs for skill s in country c in year t

Fixed costs
f_{cit}=Fixed set-up cost in country c associated with staffing level i in year t
f_{mct}ⁱⁿ=Fixed cost associated with moving mission m into country c in year t
f_{mct}^{out}=Fixed cost associated with moving mission m out of country c in year t
f_{cjt}^{ru}=Fixed cost in country c associated with non-mission ramp-up level j in year t
f_{ckt}^{rd}=Fixed cost in country c associated with non-mission ramp-down level k in year t

Incentive costs
p_{ct}=Penalty for missing incentive requirement in country c in year t
r_{ct}=Reward for meeting incentive requirement in country c in year t

While not shown here, the formulation can be easily modified such that all components of fixed and variable costs can be based on whether incentive requirements are satisfied. Further, one could also define the ranks and thresholds for any quantitative factor such as labor rates and define qualitative constraints in addition to modeling the direct costs as above.

Decision Variables (These describe the sourcing strategy)

### Allocation Decisions

X1_{cmt}=1, if mission m is assigned to country c in year t and if the incentive contract requirements are satisfied
Y1_{csut}=amount non-mission skill s of unit u that is assigned to country c in year t;
   Y1_{cut}>0 only if the incentive contract requirements are satisfied
X2_{cmt}=1, if mission m is assigned to country c in year t and if the incentive contract requirements are NOT satisfied
Y2_{csut}=amount non-mission skill s of unit u that is assigned to country c in year t;
   Y2_{csut}>0 only if the incentive contract requirements are NOT satisfied

Location decisions
V_{uct}=1, if we source for business unit u in country c in year t
W_{ct}=1, if we source in country c in year t
U_{ct}=1, if we meet incentive contract requirements in country c in year t

Staffing level decisions
Z_{ict}=1, if staffing level i is used in country c in year t
R_{mct}⁺=1 if we move mission m into country c in year t
R_{mct}⁻=1 if we move mission m out of country c in year t
I_{sct}⁺=head count ramp-up in non-mission skill s in country c in year t
I_{sct}⁻=head count ramp-down in non-mission skill s in country c in year t
Z_{jct}^{ru}=1, if ramp-up level j is used for non-mission skills in country c in year t
Z_{kct}^{rd}=1, if ramp-down level k is used for non-mission skills in country c in year t

Objective Function:

$$Min {\sum }_{c , i , t} {f}_{cit} {Z}_{ict} + {\sum }_{m , c , t} {f}_{mct}^{i n} {R}_{mct}^{+} + {\sum }_{m , c , t} {f}_{mct}^{out} {R}_{mct}^{-} + {\sum }_{j , c , t} {f}_{cjt}^{rn} {Z}_{cjt}^{rn} + {\sum }_{k , c , t} {f}_{ckt}^{rd} {Z}_{ckt}^{rd} + {\sum }_{s , c , t} {c}_{sct}^{i n} ( {I}_{sct}^{+} + {\sum }_{m} {a}_{smt} {R}_{mct}^{+} ) + {\sum }_{s , c , t} {c}_{sct}^{out} ( {I}_{sct}^{-} + {\sum }_{m} {a}_{smt} {R}_{mct}^{-} ) + {\sum }_{s , c , t} l {r}_{sct}^{lo} ( {\sum }_{m} {a}_{smt} X {1}_{cmt} + {\sum }_{u} Y {1}_{csut} ) + {\sum }_{s , c , t} l {r}_{sct}^{h i} ( {\sum }_{m} {a}_{smt} X {2}_{cmt} + {\sum }_{u} Y {2}_{csut} ) + {\sum }_{c , t} {p}_{ct} ( {W}_{ct} - {U}_{ct} ) - {\sum }_{c , t} {r}_{cl} {U}_{ct}$$

The first line of the above objective function represents the fixed costs of staffing, ramping-up and ramping-down in a country. The second line represents the variable costs of ramping-up and ramping-down in a country, the third line represents the variable costs of staffing in a country and the fourth line represents the costs due to incentive contracts.

Constraints:

Constraints to ensure that all missions are staffed in exactly one country:

$${\sum }_{c} X {1}_{cmt} + {\sum }_{c} X {2}_{cmt} = 1 , ∀ m , t$$

Constraints to ensure that all non-mission skills are staffed:

$${\sum }_{c} Y {2}_{csut} + {\sum }_{c} Y {2}_{csnt} = {a}_{sut}^{′} , ∀ s , u , t$$

Constraints to ensure that one does not staff more than available supply:

$${\sum }_{m} {a}_{mst} X {1}_{cmt} + {\sum }_{u} Y {1}_{csut} + {\sum }_{m} {a}_{mst} X {2}_{cmt} + {\sum }_{u} Y {2}_{csnt} \leq u {b}_{sct} , ∀ s , c , t$$

Constraints to ensure business preferences on number of countries staffed:

$${\sum }_{m , s} {a}_{mst} {b}_{mn} X {1}_{cmt} + {\sum }_{s} Y {1}_{csnt} + {\sum }_{m , s} {a}_{mst} {b}_{mn} X {2}_{cmt} + {\sum }_{s} Y {2}_{csnt} \leq ( {\sum }_{s} {a}_{snt}^{′} + {\sum }_{m , s} {a}_{smt} {b}_{mn} ) {V}_{uct} , {∀}_{uct} , ∀ u , c , t$$

$${\sum }_{c} {V}_{uct} \leq u b {c}_{ut} , ∀ u , t$$

$${V}_{uct} \leq {W}_{ct} , ∀ u , c , t$$

$${V}_{uct} \leq {V}_{c , t + 1} , ∀ u , c , t$$

Constraints to ensure that qualitative thresholds are met (qualitative constraints that are used in the sourcing analysis process)

rho_{cq}≦Threshold_{uq}Vₙₑₜ, ∀u, c, t, q

Constraints to determine if incentive contracts are met:
a. Check the headcount by skill level

$${\sum }_{m} {a}_{mst} X {1}_{cmt} + {\sum }_{u} Y {1}_{csut} \geq l {b}_{sct} {U}_{ct} , ∀ s , c , t$$

b. Check total headcount

$${\sum }_{s , m} {a}_{mst} X {1}_{cmt} + {\sum }_{s , n} Y {1}_{csut} \geq l b {tot}_{ct} {U}_{ct} , ∀ c , t$$

c. Check number of missions staffed

$${\sum }_{m} X {1}_{cmt} \geq l b {m}_{ct} {U}_{ct} , ∀ c , t$$

Linkage constraints

$${\sum }_{m , s} {a}_{mst} X {1}_{cmt} + {\sum }_{u , s} Y {1}_{csut} \leq {U}_{ct} {\sum }_{s} u {b}_{sct} , ∀ , c , t$$

$${\sum }_{m , s} {a}_{mst} X {2}_{cmt} + {\sum }_{u , s} Y {2}_{csut} \leq ( 1 - {U}_{ct} ) {\sum }_{s} u {b}_{sct} , ∀ , c , t$$

$${U}_{ct} \leq {W}_{ct} , ∀ c , t$$

Constraints to determine staffing levels

$${\sum }_{s , u} Y {1}_{csut} + {\sum }_{m , s} {a}_{mst} X {1}_{cmt}^{1} + {\sum }_{s , u} Y {2}_{csut} + {\sum }_{m , s} {a}_{mst} X {2}_{cmt} \leq {\sum }_{i} {cap}_{ic} {Z}_{ict} , ∀ c , t$$

$${\sum }_{i} {Z}_{ict} \leq 1 , ∀ c , t$$

Constraints to determine ramp-up/ramp-down levels

$$\begin{matrix}{R}_{mct}^{+} - {R}_{mct}^{-} = X {1}_{cmt} - X {1}_{c m , t - 1} + X {2}_{cmt} - \\ X {2}_{c m , t - 1} , ∀ m , c , t > 1\end{matrix}$$

$${R}_{m c 1}^{+} - {R}_{m c 1}^{-} = X {1}_{c m 1} + X {2}_{c m 1} - {cur}_{m c}$$

$$\begin{matrix}{I}_{sct}^{+} - {I}_{sct}^{-} = {\sum }_{u} Y {1}_{csut} + {\sum }_{n} Y {2}_{csut} - {\sum }_{u} Y {1}_{csn , t - 1} - \\ {\sum }_{u} Y {2}_{csu , t - 1} , ∀ s , c , t > 1\end{matrix}$$

$${I}_{sc 1}^{+} - {I}_{sc 1}^{-} = {\sum }_{u} Y {1}_{csu 1} + {\sum }_{u} Y {2}_{csu 1}^{2} - {cur}_{sc} , ∀ s , c$$

$${\sum }_{s} {I}_{sct}^{+} \leq {\sum }_{j} r {u}_{jc} {Z}_{jct}^{ru} , ∀ c , t$$

$${\sum }_{j} {Z}_{jct}^{ru} \leq 1 , ∀ c , t$$

$${\sum }_{s} {I}_{sct}^{-} \leq {\sum }_{k} r {u}_{kc} {Z}_{kct}^{rd} , ∀ c , t$$

$${\sum }_{k} {Z}_{kct}^{rd} \leq 1 , ∀ c , t$$

The above mathematical program can be solved using user-preferred solver to obtain the sourcing strategy for a given set of qualitative thresholds. This is then used in the sourcing analysis process to determine the sourcing strategy that optimizes the trade-off between long-term costs and qualitative gains.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server.

The embodiments described above are illustrative examples and it should not be construed that the present invention is limited to these particular embodiments. Thus, various changes and modifications may be effected by one skilled in the art without departing from the spirit or scope of the invention as defined in the appended claims.

We claim:

1. A computer implemented method for determining a global resource sourcing strategy for an organization over one or more time periods, comprising:
incorporating concurrently a plurality of qualitative and quantitative attributes that influence performance of sourcing strategy with respect to one or more quantitative measures;
quantifying an impact of said qualitative attributes using said one or more quantitative measures; and
optimizing the sourcing strategy with respect to said one or more quantitative measures subject to one or more constraints.

2. The method of claim 1, wherein said one or more quantitative measures include one or more numerical values that can be correlated to the sourcing strategy.

3. The method of claim 1, wherein said qualitative attribute include one or more attributes that can be ranked to model a quality level for the sourcing strategy.

4. The method of claim 1, wherein the sourcing strategy is for human resource planning for an organization.

5. The method of claim 1, wherein one or more of said plurality of qualitative and quantitative attributes are determined from human resource information, a common database with quantitative, qualitative and availability data, or one or more business units, or combinations thereof.

6. The method of claim 1, wherein the step of optimizing outputs sourcing recommendations.

7. The method for claim 1, wherein the step of optimizing includes:
modeling a total cost using fixed and variable costs on moves and staffing levels;
modeling one or more constraints;
modeling one or more incentives and preferences; and
using a continuous, discrete or mixed continuous and discrete mathematical program.

8. A system for determining a global resource sourcing strategy for an organization over one or more time periods, comprising:
a computer processor operable to incorporate concurrently a plurality of qualitative and quantitative attributes that influence performance of sourcing strategy with respect to one or more quantitative measures, the computer processor further operable to quantify an impact of said qualitative attributes using said one or more quantitative measures; and
an optimizer module operable to optimize the sourcing strategy with respect to said one or more quantitative measures subject to one or more constraints.

9. The system of claim 8, wherein the computer processor is further operable to model a total cost using fixed and variable costs on moves and staffing, model one or more constraints and model one or more incentives and preferences.

10. The system of claim 9, wherein the optimizer module uses a continuous, discrete or mixed continuous and discrete mathematical program.

11. The system of claim 8, wherein said one or more quantitative measures include one or more numerical values that can be correlated to the sourcing strategy.

12. The system of claim 8, wherein said qualitative attribute include one or more attributes that can be ranked to model a quality level for the sourcing strategy.

13. The system of claim 8, wherein the sourcing strategy is for human resource planning for an organization.

14. The system of claim 8, wherein one or more of said plurality of qualitative and quantitative attributes are determined from human resource information, a common database with quantitative, qualitative and availability data, or one or more business units, or combinations thereof.

15. The system of claim 8, wherein the step of optimizing outputs sourcing recommendations.

16. A program storage device readable by a machine, tangibly embodying a program of instructions executable by the machine to perform a method of determining a global resource sourcing strategy for an organization over one or more time periods, comprising:
incorporating concurrently a plurality of qualitative and quantitative attributes that influence performance of sourcing strategy with respect to one or more quantitative measures;
quantifying an impact of said qualitative attributes using said one or more quantitative measures; and
optimizing the sourcing strategy with respect to said one or more quantitative measures subject to one or more constraints.

17. The program storage device of claim 16, wherein said one or more quantitative measures include one or more numerical values that can be correlated to the sourcing strategy.

18. The program storage device of claim 16, wherein said qualitative attribute include one or more attributes that can be ranked to model a quality level for the sourcing strategy.

19. The program storage device of claim 16, wherein the sourcing strategy is for human resource planning for an organization

20. The program storage device of claim 16, wherein one or more of said plurality of qualitative and quantitative attributes are determined from human resource information, a common database with quantitative, qualitative and availability data, or one or more business units, or combinations thereof.
